(19) United States
(12) Patent Application Publication
(10) Pub. No.: US 2010/0125754 A1
(43) Pub. Date: May 20, 2010

(54) METHOD FOR ACCESSING A BIG STRUCTURE IN A 64K OPERATING ENVIRONMENT

(75) Inventor: Chung-Chiang CHEN, TAIPEI CITY (TW)

Correspondence Address: BRIAN M. MCINNIS, 12th Floor, Ruttonjee House, 11 Duddell Street, Hong Kong, HK

(73) Assignee: INVENTEC CORPORATION, TAIPEI CITY (TW)

(21) Appl. No.: 12/357,413

(22) Filed: Jan. 22, 2009

(30) Foreign Application Priority Data
Nov. 19, 2008 (TW) 97144695

(51) Int. Cl. G06F 11/27

(52) U.S. Cl. 714/36; 714/E11.169

(57) ABSTRACT

A method for accessing a big structure in a 64 k operating environment is disclosed. The method includes changing the big structure into plural sub structures; arranging a big memory space by a power on self test (POST) memory manager; and allocating the sub structures to the big memory space. Wherein a length of each sub structure is shorter than 64k

### RELATED APPLICATIONS

This application claims priority to Taiwan Application Serial Number 97144695, filed Nov. 19, 2008, which is herein incorporated by reference.

### BACKGROUND

1. Field of Invention

The present invention relates to an access method. More particularly, the present invention relates to an access method in a 64 k operating environment.

2. Description of Related Art

The option ROM and the DOS operating environment belong to a 16-bit operating environment. The size of the 16-bit operating environment is represented as 2¹⁶, i.e. 65536, which can be written as 64 k. The variable values of the program are mostly stored in a stack in the operating environment. However, the length of the data structure stored in the 64 k operating environment is limited by the size of the operating environment, and the length of the data structure cannot be longer than 64 k to prevent the data structures from stacking overlap. Data structures larger than 64 k are stacked as overlaps in the operating environment, and the address of the data structure would be calculated incorrectly.

Although the programs in a conventional 64 k operating environment don't use structures larger than 64 k, there may be a need to use a big structure, which is larger than 64 k, in the 64 k operating environment. The conventional solution for using the big structure in the 64 k operating environment is to store the big structure in a hard disk device. The program would access an appointed attribute of the big structure in the hard disk device when the appointed attribute is required. However, the above solution requires a lot of input/output time on the disk head.

### SUMMARY

One embodiment of the invention provides a method for accessing a big structure in a 64 k operating environment. The method includes changing the big structure into plural sub structures; arranging a big memory space by a power on self test (POST) memory manager; and allocating the sub structures to the big memory space. Wherein a length of each sub structure is shorter than 64 k

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1A and FIG. 1B are schematic diagrams of different state of a first embodiment of the method of the invention;

FIG. 2 is a schematic diagram of a second embodiment of the method of the invention;

FIG. 3 is a flow chart diagram of a third embodiment of the method of the invention;

FIG. 4 is a schematic diagram of the third embodiment of the invention;

FIG. 5 is a flow chart diagram of a fourth embodiment of the method of the invention; and

FIG. 6 is a schematic diagram of the fourth embodiment of the invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The big size data structure, which is bigger than 64 k cannot be stored in the 64 k operating environment directly, thus the present invention provides a method to accomplish accessing a big structure in the 64 k operating environment, which can change the big structure into plural sub structures and provide a big memory space by a power on self test (POST) memory manager to store the sub structures. Thus the big structure would not be stacked overlap in the 64 k operating environment.

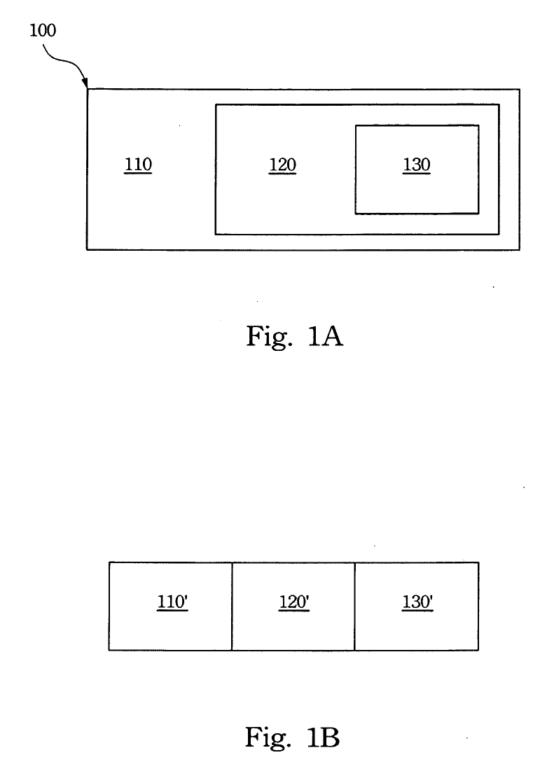

Refer to FIG. 1A and FIG. 1B simultaneously. FIG. 1A and FIG. 1B illustrate schematic diagrams of different states of the first embodiment of the method of the invention. A big structure 100 is provided in FIG. 1A. The size of the big structure 100 is larger than 64 k. The initial state of the big structure 100 is constructed of plural substructures 110, 120, and 130. The first sub structure 110 includes the second sub structure 120, and the second substructure 120 further includes the third sub structure 130, thus the size of the big structure 100 is really huge when the big structure 100 is declared, and the big structure 100 cannot be accessed directly in the 64 k operating environment.

The method for accessing a big structure 100 in the 64 k operating environment of the embodiment can disassemble the big structure 100, and the big structure 100 is disassembled into plural sub structures 110′, 120′, and 130′. The second sub structure 120′ can be disassembled form the first sub structure 110′, and the third sub structure 130′ can be disassembled from the second sub structure 120′.

Note that the first sub structure 110′ is disassembled by the method of the embodiment and would no longer include the second sub structure 120′, and the second sub structure 120′ disassembled by the method of the embodiment and would no longer include the third sub structure 130′. The first sub structure 110′, the second sub structure 120′, and the third sub structure 130′ which have been disassembled can be declared individually, and the length of the program declaration can be reduced.

The big structure 100 can be disassembled by the method of the embodiment, and the length of the first sub structure 110′, the second sub structure 120′, and the third sub structure 130′ can be preferably shorter than 64 k to meet the stack limitation in the 64 k operating environment. However, if the length of the first sub structure 110′, the second sub structure 120′, or the third sub structure 130′ is still larger than 64 k, the method of the invention can provide another embodiment to further shorten the length of the sub structures.

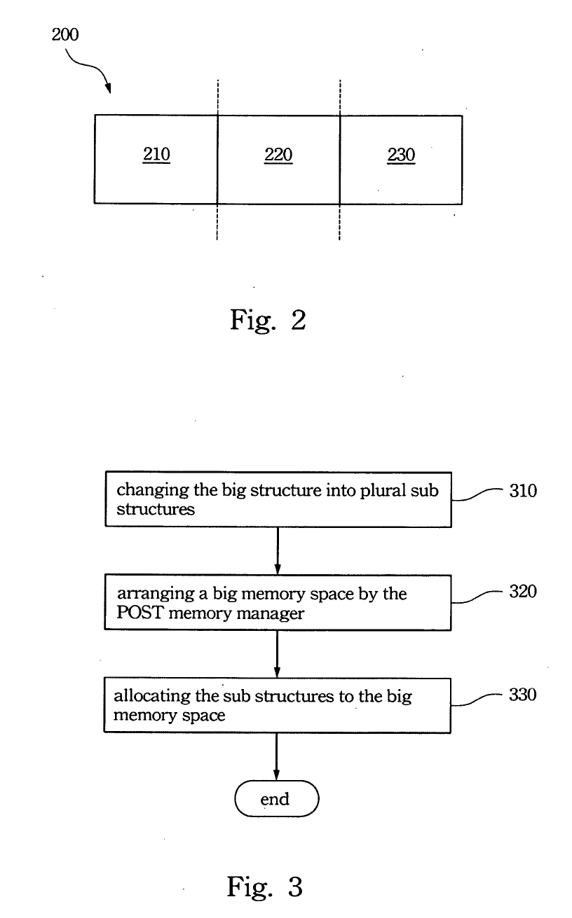

Refer to FIG. 2. FIG. 2 illustrates schematic diagram of a second embodiment of the method of the invention. The method in this embodiment can cut the big structure 200 into plural sub structures 210, 220, and 230, and the length of each substructure 210, 220, and 230 is shorter than 64 k to meet the stack limitation in the 64 k operating environment.

The big structure can be changed into plural substructures by using one or both of the embodiments of the method of the invention. The sub structures can be changed into plural sub structures, and the length of each sub structure is smaller than 64 k to meet the stack limitation in the 64 k operating environment, thus the sub structures can be stored in the 64 k operating environment directly.

Refer to FIG. 3. FIG. 3 illustrates a flow chart diagram of a third embodiment of the method of the invention. The big structure is changed into plural sub structures in step 310, wherein the length of each sub structure is shorter than 64 k. Step 320 arranges a big memory space by the POST memory manager (PMM). Step 330 allocates the sub structures to the big memory space, wherein the length of each sub structure is shorter than 64 k.

The big structure in step 310 is changed into plural sub structures in step 310. The big structure can be disassembled into plural sub structures as disclosed in the first embodiment, or the big structure can be cut into the plural sub structures as disclosed in the second embodiment. The big structure can also be disassembled and cut to become plural sub structures. The length of each sub structure is shorter than 64 k to meet the stack limitation of the 64 k operating environment.

The big memory space is arranged by the POST memory manager at the power on self test (POST) state in step 320. More particularly, the big memory space is arranged by the POST memory manager at a big real mode of the POST state. The program of the option ROM for the power on self test is mostly operated at a memory space under 1 MB. Thus the big memory space for allocating the sub structures is preferably arranged at the memory space, which is higher than 1 MB to distinguish from the memory space where the option ROM programs operated.

Step 330 further includes recording an initial address of the big memory space and calculating an initial address of each sub structure.

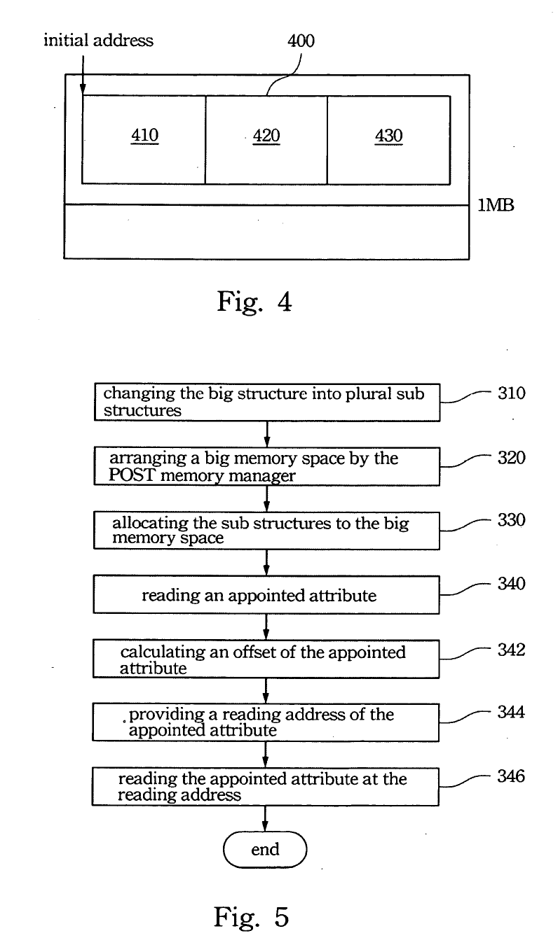

Refer to FIG. 4. FIG. 4 illustrates a schematic diagram of the third embodiment of the invention. The big structure 400 has been changed into plural sub structures 410, 420, and 430, wherein the length of each sub structure 410, 420, or 430 is shorter than 64 k. The sub structures 410, 420, and 430 are allocated in the big memory space higher than 1 MB, which is arranged by the POST memory manager. The initial address of the big memory space can be regarded as the initial address of the first sub structure 410. The initial address of the second substructure 420 is combining the initial address of the first sub structure 410 and the length of the first sub structure 410. The initial address of the third sub structure 430 is combining the initial address of the second sub structure 420 and the length of the second sub structure 420.

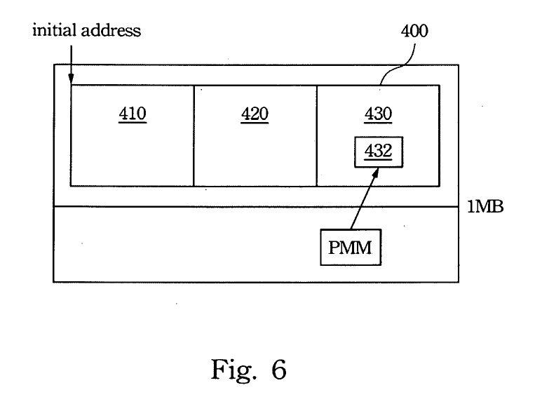

Refer to FIG. 5 and FIG. 6 simultaneously. FIG. 5 illustrates a flow chart diagram of a fourth embodiment of the method of the invention. FIG. 6 illustrates a schematic diagram of the fourth embodiment of the invention. The method for accessing the big structure in the 64 k operating environment further includes step 340 to read an appointed attribute 432. The appointed attribute 432 in this embodiment is in the third sub structure 430.

Step 342 calculates an offset of the appointed attribute 432 in the third sub structure 430, and step 344 is combining the initial address of the third sub structure 430 and the offset of the appointed attribute 432 to provide a reading address of the appointed attribute 432. The initial address of the third sub structure 430 is generated by adding the initial address of the first sub structure 410, the length of the first sub structure 410, and the length of the second sub structure 420. Step 346 is reading the appointed attribute 432 at the reading address by the POST memory manager.

The embodiments of the method of the invention can accomplish accessing the big structure in the 64 k operating environment by changing the big structure into plural sub structures. The length of each sub structure is shorter than 64 k to meet the stack limitation in the 64 k operating environment. The sub structures can be stored in the memory space higher than 1 MB by the POST memory manager, and the POST memory manager can read the appointed attribute thereof.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for accessing a big structure in a 64 k operating environment comprising:
changing a big structure into a plurality of sub structures, wherein a length of each sub structure is shorter than 64 k;
arranging a big memory space by a power on self test (POST) memory manager; and
allocating the sub structures to the big memory space.

2. The method for accessing a big structure in a 64 k operating environment of claim 1, wherein changing the big structure into the plurality of sub structures is to disassemble the big structure into the plurality of sub structures.

3. The method for accessing a big structure in a 64 k operating environment of claim 1, wherein changing the big structure into the plurality of sub structures is to cut the big structure to the plurality of sub structures.

4. The method for accessing a big structure in a 64 k operating environment of claim 1, wherein the big memory space is arranged by the POST memory manager at a power on self test (POST) state.

5. The method for accessing a big structure in a 64 k operating environment of claim 1, wherein the big memory space is arranged higher than 1 MB.

6. The method for accessing a big structure in a 64 k operating environment of claim 1, further comprising calculating an initial address of each sub structure.

7. The method for accessing a big structure in a 64 k operating environment of claim 6, further comprising recording an initial address of the big memory space and the length of each sub structure.

8. The method for accessing a big structure in a 64 k operating environment of claim 6, further comprising reading an appointed attribute.

9. The method for accessing a big structure in a 64 k operating environment of claim 8, further comprising calculating an offset of the appointed attribute in the sub structure thereof.

10. The method for accessing a big structure in a 64 k operating environment of claim 9, further comprising combining the initial address of the sub structure of the appointed attribute and the offset to provide a reading address of the appointed attribute.

11. The method for accessing a big structure in a 64 k operating environment of claim 10, further comprising reading the appointed attribute at the reading address by the POST memory manager.
